(19) United States
(12) Patent Application Publication
(10) Pub. No.: US 2011/0106885 A1
(43) Pub. Date: May 5, 2011

(54) METHODS AND APPARATUS FOR SUPPORTING MULTIPLE PARTY LOGIN INTO A SINGLE SESSION

(75) Inventors: John Christopher Davi, Palo Alto, CA (US); Glenn Thomas Millican, III, Mountain View, CA (US); John Toebes, Cary, NC (US)

(73) Assignee: CISCO TECHNOLOGY, INC., San Jose, CA (US)

(21) Appl. No.: 12/608,306

(22) Filed: Oct. 29, 2009

(51) Int. Cl. G06F 15/16

(52) U.S. Cl. 709/204; 709/227

(57) ABSTRACT

In one embodiment, a method includes establishing a session by associating at least a first party with the session. The first party is associated with a first device, and is associated with the session through the first device. The method also includes defining an effective user to include the first party, tracking actions taken with respect to the session by the effective user, and attributing the actions taken with respect to the session by the effective user to the first party and to the effective user.

### BACKGROUND

The present disclosure relates generally to networking, and more particularly to collaborative and social networking.

Multiple parties often use a shared device to view media. For example, a family may sit in front of a computer screen to view a movie streamed from a web server, or several people may view web content on a screen of a mobile phone.

Generally, when a party is required to log into a website in order to view content, only one party may log into the website, even if multiple parties subsequently view the content associated with the website. Thus, actions taken with respect to the website may be attributed only to the single party that is logged into the website, and not to other parties who are also viewing the website. By way of example, while the multiple parties may browse specific products on a website, the viewing of information associated with the specific products may only be attributed to the single party that is logged into the website. As such, even though other parties also viewed the products, the information associated with the specific products is not attributed to them. When that information is not attributed to the other parties, the viewing histories of those parties may not be entirely accurate.

### BRIEF DESCRIPTION OF THE DRAWINGS

The embodiments of this disclosure will be readily understood by the following detailed description in conjunction with the accompanying drawings in which:

FIG. 1 is a block diagram representation of a system which allows multiple parties to use a shared client device to log into a single session in accordance with an embodiment.

FIG. 2 is a process flow diagram which illustrates a method of allowing more than one party to utilize a shared client device to effectively log into a single session in accordance with an embodiment.

FIG. 3A-C are a process flow diagram which illustrates a method of presenting recommendations to an effective user that includes a plurality of parties in accordance with an embodiment.

FIG. 4 is a diagrammatic representation of a client which includes functionality configured to enable multiple parties to take part in a session in accordance with an embodiment.

FIG. 5 is a diagrammatic representation of a server which includes functionality configured to enable multiple parties to take part in a session in accordance with an embodiment.

FIG. 6A is a diagrammatic representation of a session established for an effective user associated with a first set of parties at a time t1 in accordance with an embodiment.

FIG. 6B is a diagrammatic representation of a session established for an effective user, e.g., session 616 of FIG. 6A, at a time t2 when a first new party joins the user in accordance with an embodiment.

FIG. 6C is a diagrammatic representation of a session established for an effective user, e.g., session 616 of FIG. 6A, at a time t3 when a second new party joins the user in accordance with an embodiment.

FIG. 6D is a diagrammatic representation of a session established for an effective user, e.g., session 616 of FIG. 6A, at a time t5 when one party leaves the user in accordance with an embodiment.

### DESCRIPTION OF EXAMPLE EMBODIMENTS

### General Overview

According to one aspect, a method includes establishing a session by associating at least a first party with the session. The first party is associated with a first device, and is associated with the session through the first device. The method also includes defining an effective user to include the first party, tracking actions taken with respect to the session by the effective user, and attributing the actions taken with respect to the session by the effective user to the first party and to the effective user.

### DESCRIPTION

In one embodiment, two or more parties, e.g., people, are allowed to log into or otherwise access the same browsing or interaction session of a device. For example, multiple parties may use a shared client device to log into a shared web or hypertext transfer protocol (http) session. Thus, events occurring during the shared session may be attributed to substantially all of the parties that are logged into the session. More generally, actions taken during the session may be attributed to substantially all of the parties that are logged into the session. The actions may include, but are not limited to including, events, behaviors, gestures, and/or activities occurring during the session.

By allowing multiple parties to be substantially authenticated with respect to a shared session, the shared session may effectively be bound to multiple parties or to multiple individual accounts. Hence, actions occurring during the shared session may be attributed to the multiple parties as a group as well as individually to each of the multiple parties.

A group of parties, or even a single party, that are logged into a shared session may be considered to be an “effective” user. As such, actions taken during the session may be attributed to individual parties as well as to the effective user. By way of example, if a particular webpage is viewed during a shared session, the fact that the webpage was accessed may be ascribed to the effective user as well as to each party associated with the effective user. The effective user may effectively identify a group of parties by a single name.

Recommendations may be made to an effective user, as well as to parties associated with the effective user, based on actions previously taken by the effective user. For example, for a retail web page on which recommendations are provided to suggest products that may be of interest to the effective user, the recommendations may take into account web pages and/or products that were previously viewed by the effective user. In addition, when an individual party accesses a retail web page on which recommendations are provided to suggest products that may be of interest to the individual party, the recommendations may also take into account web pages and/or products that were previously viewed by an effective user with which the individual party was associated.

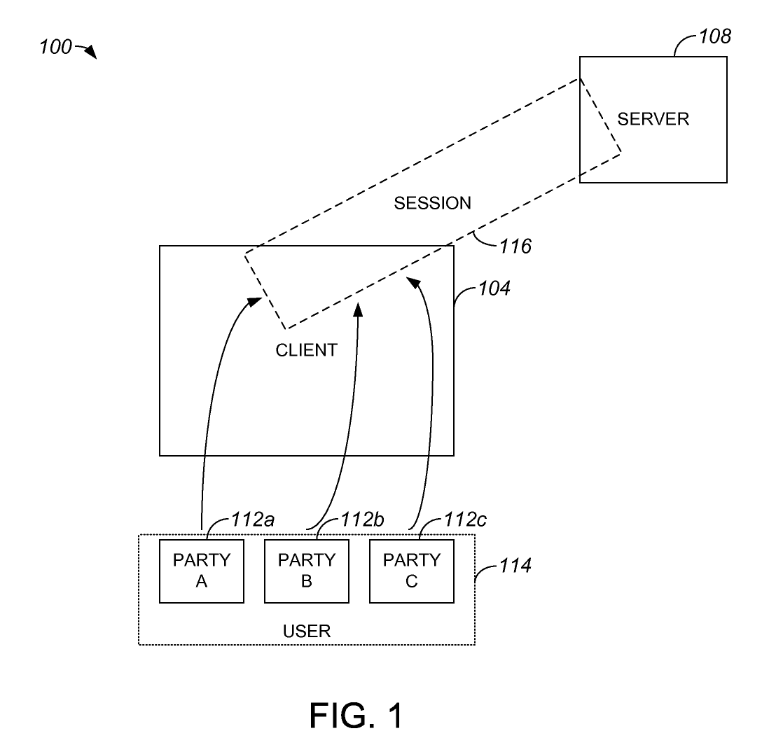

Referring initially to FIG. 1, a system which allows multiple parties to use a shared client device to log into a single session will be described in accordance with an embodiment. A system 100 includes a client 104 and a server 108. Client 104 may be any suitable client which communicates with server 108 through a network. Client 104 may include, but is not limited to including, a computing system, a phone, a gaming console, and a media player.

A session 116 between client 104 and server 108 is established, and parties 112a-c are each logged into session 116. In the described embodiment, parties 112a-c may individually log into session 116 via client 104. Client 104 may present an interface, e.g., a graphical user interface, which allows parties 112a-c to enter account information such as user names and passwords that allows parties 112a-c to be authenticated by client 104 and, hence, logged into session 116. Alternatively, client 104 may be arranged to substantially automatically detect the presence of parties 112a-c, and authenticate parties 112a-c once parties 112a-c are detected.

Parties 112a-c may form an effective user 114. For instance, parties 112a-c may be grouped and substantially defined as effective user 114. Client 104 typically recognizes that parties 112a-c may be grouped together as effective user 114, and attributes or binds actions taken with respect to session 116 to effective user 114 as a whole, as well as to parties 112a-c individually. For example, if session 116 is an http session during which a particular web page is viewed, the viewing may be substantially automatically attributed to effective user 114, party A 112a, party B 112b, and to party C 112c.

Parties 112a-c utilize client 104. That is, client 104 is shared by parties 112a-c. Parties 112a-c may establish and substantially maintain session 116 through the use of client 104.

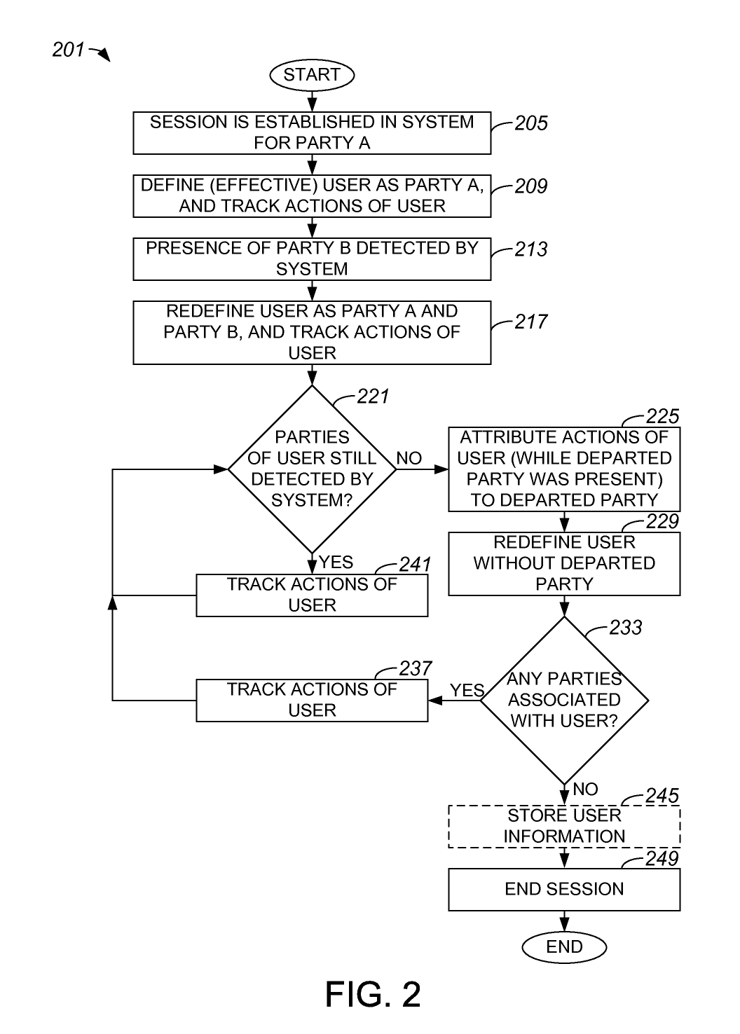

FIG. 2 is a process flow diagram which illustrates a method of allowing more than one party to utilize a shared client device to effectively log into a single session in accordance with an embodiment. A method 201 of allowing a plurality of parties to effectively log into a single session begins at step 205 in which a session, e.g., an http session, is established in a system for party A. The session may be established in a variety of different ways. For example, the session may be established when party A logs into the system and is substantially authenticated by the system, or the system may be established when the system essentially senses the presence of party A. A system may include a client and a server. Party A may interact with the client to establish a session in the system. The client may be, but is not limited to being, a computing system, a gaming console, a mobile phone, and/or a portable media player.

Once a session is established, an “effective” user may be defined as including party A in step 209, and actions of the user may be tracked. The effective user may be defined, in one embodiment, to be the set of parties at a current time which are logged into the session. As party A is logged into the session, and no other party is currently logged into the session, the effective user is defined as including only party A. Tracking the actions of the effective user may include, but is not limited to including, tracking webpages and/or websites accessed by the effective user, tracking interactions with webpages and/or websites, as well as tracking media viewed by the effective user. It should be appreciated that tracking the actions of the effective user may involve storing the actions of the effective user, at least temporarily, in a data store arrangement associated with the system.

After actions of the effective user are tracked, the presence of party B is detected by the system in step 213. Party B may be detected, for example, when party B logs into the session or when the system essentially senses the presence of party B. Upon detecting the presence of party B, the system redefines the effective user as including party A and party B in step 217, and the actions of the redefined effective user are tracked.

A determination is made in step 221 as to whether the parties associated with the effective user are still detected by the system. In other words, it is determined whether any of the parties included in the effective user, e.g., party A and/or party B, has logged out or otherwise disassociated from the effective user. Such a determination may be made using a variety of different methods including, but not limited to including, identifying when a party as logged out of the session and identifying when the party is no longer sensed by the system. If it is determined that the parties of the effective user are still detected by the system, the actions of the user continue to be tracked in step 241. From step 241, process flow returns to step 221 and the determination of whether the parties associated with the effective user are still detected by the system.

If the determination in step 221 is that substantially all of the parties associated with the effective user are no longer still detected by the system, then indication is that future actions of the effective user are no longer to be attributed to at least one of the parties associated with the effective user. In the described embodiment, for ease of discussion, a single party is determined to have departed, although it should be appreciated that any number of parties associated with the effective user may depart at substantially the same time. If it is determined that a party associated with the effective user is no longer detected, then previous actions of the effective user are attributed to the party which is no longer associated with the effective user, e.g., the departed party, in step 225. In other words, the actions of the effective user which occurred while the departed party was associated with the effective user are attributed to the departed party. Attributing such actions to the departed party may include updating a profile or other information of the departed party to indicate that those actions were taken by the departed party. Further, preferences of the departed party may be updated based upon such actions.

After the actions of the effective user are attributed to the departed party, the effective user is redefined in step 229 without the departed party. That is, the effective user is redefined such that the departed party is no longer associated with the effective user. A determination is then made in step 233 as to whether there are any parties still associated with the effective user. If it is determined that there is still at least one party associated with the effective user, then the actions of the effective user are tracked in step 237. From step 237, process flow returns to step 221 in which it is determined whether substantially parties associated with the effective user are still detected by the system.

Alternatively, if the determination in step 233 is that there are no longer any parties associated with the effective user, then information relating to the effective user may optionally be stored by the system. Storing the information may enable a profile for the effective user to be created or updated. When information relating to the effective user is stored, the information may include an indication of the parties associated with the effective user when actions were taken. That is, the information may identify different incarnations of the effective user. Such information may be used to provide recommendations in the future when a user establishes a new session in the system, and the user includes the same parties associated with an incarnation of the effective user. For example, the next time a user is effectively defined as including party A and party B, the preferences stored for the effective user that relate to actions taken while party A and party B were associated with the effective user may be used to provide recommendations to the user.

In step 249, the session established in the system is ended. It should be appreciated that the session may be substantially automatically terminated once a last remaining party associated with the effective user is no longer detected by the system. After the session is ended, the process of allowing a plurality of parties to effectively log into a single session is completed.

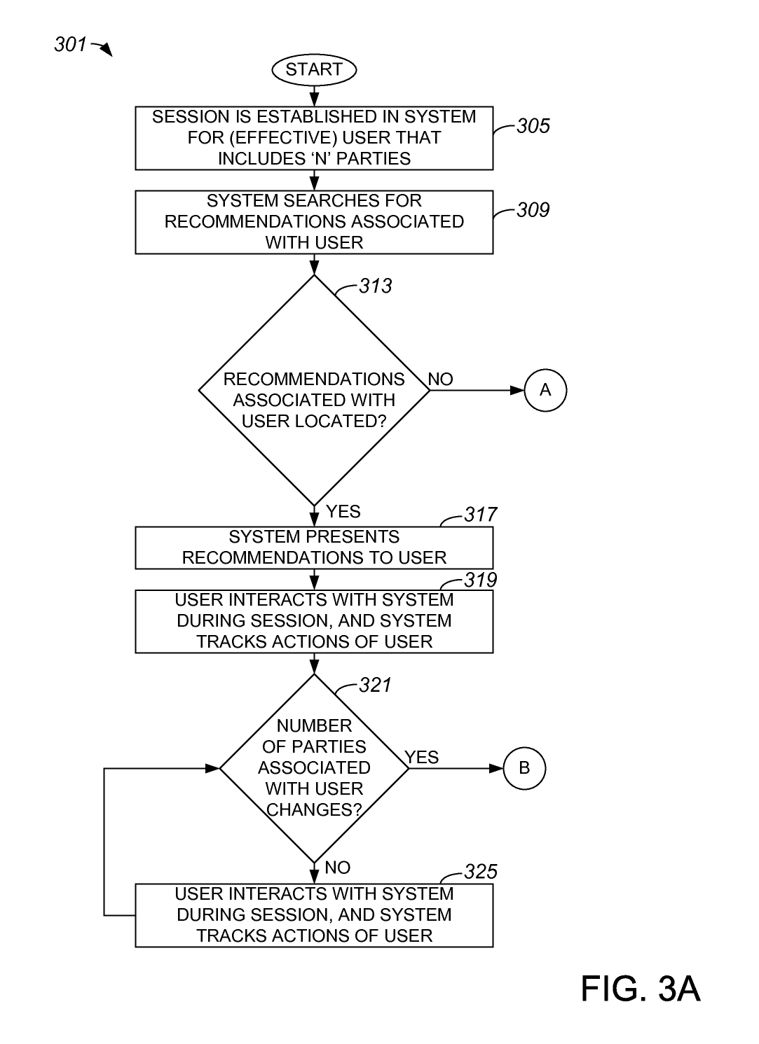

As previously mentioned, information relating to an effective user, e.g., actions taken by an effective user, may be stored by a system. The stored information may be accessed at a later time and used to present recommendations to the effective user the next time a session is established in the system that involves the effective user. With reference to FIGS. 3A-C, a method of presenting recommendations to an effective user that includes a plurality of parties will be described in accordance with an embodiment. A process 301 of presenting recommendations to an effective user begins at step 305 in which a session is established in a system for the effective user. In the described embodiment, the effective user includes ‘N’ parties, where N is an integer that is greater than or equal to one. The session may be substantially automatically established, e.g., when the system senses or otherwise detects the presence of the effective user, or the session may be established when the ‘N’ parties effectively log into the session.

Once the session is established, the system searches for recommendations associated with the effective user in step 309. The system may search a data store or other data structure in which recommendations, as well as other information relating to users of a system, may be stored. Searching for recommendations may include identifying an identifier associated with the effective user, and indexing into a data store using the identifier in order to determine whether there are recommendations associated with the effective user.

A determination is made in step 313 as to whether recommendations associated with the effective user have been located. That is, it is determined if recommendations associated with substantially all parties, e.g., all ‘N’ parties, as a group have been located. If the determination is that recommendations associated with the effective user have not been located, the indication may be that substantially all of the parties have not previously substantially all shared a session. However, a subset of the parties may have previously shared a session. Accordingly, process flow moves to step 329 in which the system searches for recommendations associated with a subset of the parties associated with the effective user.

After the system searches for recommendations associated with a subset of the parties, the system selects recommendations to present to the effective user in step 333. The recommendations may be set using any suitable parameters that may be set within the system. Such parameters may be arranged, for example, such that the recommendations corresponding to the largest subset of the parties for which recommendations are available may be selected, and/or such that the subset which includes the highest ranked or most important parties may be selected. In general, parameters used to select recommendations may vary widely.

Once recommendations are selected, the system presents the selected recommendations to the effective user in step 337. Then, process flow proceeds to step 319 in which the effective user interacts with the system, and the system tracks the actions undertaken by the effective user.

In one embodiment, a determination is made in step 321 as to whether the number of parties associated with the effective user has changed. In general, the number of parties may change when at least one additional party joins the session, or when at least one party leaves the session. For ease of discussion, it is assumed that the number of parties has changed because at least one party has left, or “unjoined” from, the session. If it is determined that the number of parties associated with the effective user has not changed, the effective user continues to interact with the system, and the system tracks actions of the effective user, in step 325. Then, process flow returns to step 321 in which it is determined if the number of parties associated with the effective user has changed.

If it is determined in step 321 that the number of parties associated with the effective user has changed, the system updates recommendations for the effective user in step 341. It should be understood that the recommendations are updated for the effective user based on actions tracked before the number of parties associated with the effective user changed. The system may store the updated recommendations may be stored in a data store.

After the system updates recommendations for the effective user, the system identifies the party which is no longer associated with the effective user in step 345. Once such a party is identified, the system updates the recommendations for that party in step 349. Updating the recommendations for the party which is no longer associated with the effective user may include attributing substantially all actions taken by the effective user, i.e., while the party was associated with the effective user, to the party.

The system redefines or otherwise modifies the effective user in step 323 such that the party identified in step 345 is no longer associated with the effective user. In one embodiment, redefining the effective user may include essentially creating a new effective user that includes a subset of the ‘N’ parties which were associated with the previous effective user. Such a new effective user may be identified by a name that is different from the name of the previous effective user, e.g., such that the new effective user may be distinguished from the previous effective user.

After the system redefines the effective user, a determination is made in step 357 as to whether the effective user, i.e., the redefined or new effective user, includes any parties. If it is determined that the effective user does not include any parties, then the session is terminated in step 361, and the process of presenting recommendations to an effective user is completed.

Alternatively, if it is determined in step 357 that the effective user still includes parties, the indication is that the effective user is still interacting with the system during the session. Accordingly, process flow returns to step 309 in which the system searchers for recommendations associated with the effective user.

Returning to step 313, if it is determined that recommendations associated with the effective user have been located, the system presents the recommendations to the effective user. Once the recommendations are presented to the effective user, the user interacts with the system during the session, and the system tracks the actions of the effective user in step 319.

In general, an overall system that allows multiple parties to log in, at substantially the same time, to a shared session may be a client-server. When the overall system is a client-server system, the multiple parties may log into a shared session using a client. Such a client may be configured to include the functionality that supports such a shared session. Alternatively, an overall system that allows multiple parties to log in, at substantially the same time, may be a standalone device such as a server.

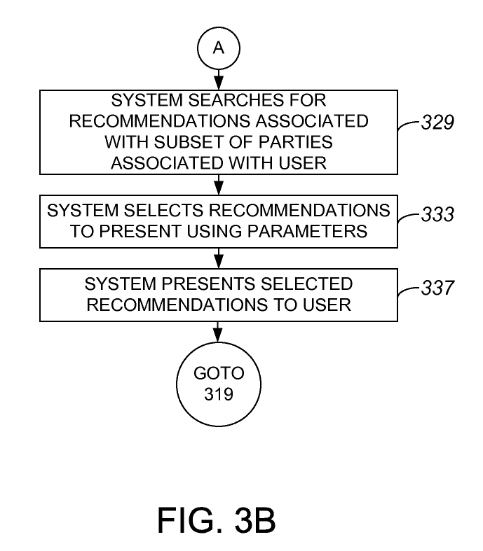

FIG. 4 is a diagrammatic representation of a client that is a part of a client-server system and is configured to enable multiple parties to take part in a shared session in accordance with an embodiment. A client 404, which may be substantially any device which is suitable for use in establishing a shared session includes an interactive interface arrangement 420. Interactive interface arrangement 420 may include hardware and/or software logic that is generally arranged to enable a party (not shown) to interact with client 404. In one embodiment, interactive interface arrangement 420 may include a user interface that allows a party (not shown) to provide account information to client 404 that allows the party to log into a session. In another embodiment, interactive interface arrangement 420 may include a sensing arrangement configured to effectively sense or detect the presence of a party or parties (not shown) in the vicinity of client. It should be appreciated that a camera (not shown) or similar imaging device may also be included on client 404.

Client 404 also includes a data store 428 in which recommendations, account information associated with parties (not shown) that may utilize client 404, and/or other information pertaining to the parties may be stored. Data store 428 may be a memory arrangement or a data base that is arranged to store information in a substantially searchable manner.

Application logic 432 includes hardware and/or software logic that is configured to establish a shared session and to allow parties (not shown) to effectively utilize client 404. Application logic 432 may generally be arranged to facilitate the execution of an application that is associated with the shared session on client 404, e.g., when processing arrangement executes application logic 432, and to track actions undertaken with respect to the shared session. For example, if the shared session is a web or http session, the application associated with the shared session may be a web browser application, and the application may effectively actions such as web page access.

Application logic 432 may include session establishment logic 440, recommendation logic 444, effective user creation logic 448, and party identification logic 450. Session establishment logic 440 may be configured to allow a shared session to be initialized or otherwise opened, and maintained. The shared session is effectively established between client 404 and a server (not shown). Recommendation logic 444 may generally identify actions associated with parties logged into the shared session, and process the actions to identify recommendations to present to parties logged into the shared session. Recommendation logic 444 may also be arranged to store recommendations, as for example in data store 428 or on a server (not shown), and to obtain stored recommendations. Effective user creation logic 448 is configured to identify parties logged into a shared session at any given time, and to create an effective user that includes the identified parties at the given time. Party identification logic 450 is typically configured to identify parties attempting to log into a shared session. In one embodiment, party identification logic 450 may authenticate parties prior to enabling the parties to log into a shared session.

A server interface arrangement 424 is generally arranged to enable client 404 to communicate with a server (not shown). Server interface arrangement 424 may include ports (not shown) configured to send information, e.g., wirelessly and/or through a wired communications link, to a server (not shown). In one embodiment, if recommendations, or information arranged to be processed to obtain recommendations, is not stored in data store 428, the recommendations or information may instead be stored on a server (not shown). When recommendations are stored on a server (not shown), server interface arrangement 424 may be configured to enable client 404 to obtain the recommendations.

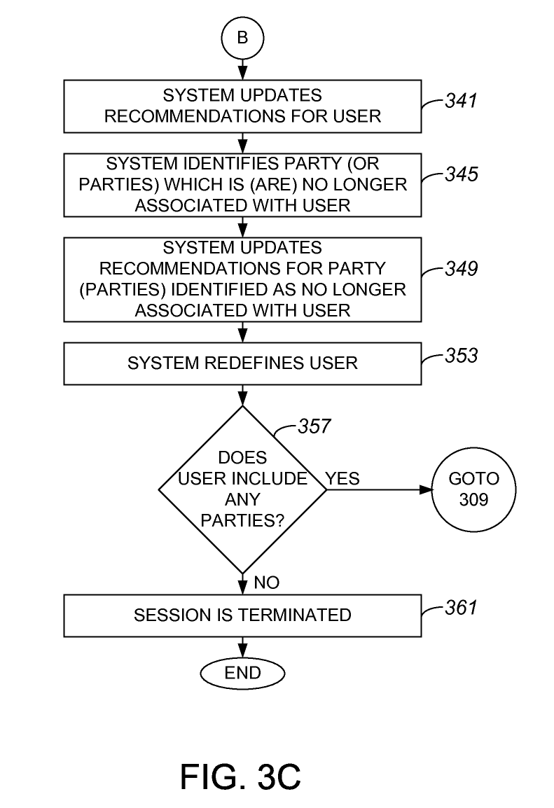

As previously mentioned, an overall system that allows multiple parties to log into a shared session may include a substantially standalone device such as a server. FIG. 5 is a diagrammatic representation of a server which includes functionality configured to enable multiple parties to take part in a shared session in accordance with an embodiment. A server 508 may be any suitable device such as a computing system or a gaming console. Server 508 includes an interface arrangement 552 that may be arranged to receive input from parties attempting to create or log into a shared session. In one embodiment, interface arrangement 552 may substantially automatically sense the presence of parties. For example, interface arrangement 552 may include a camera and facial recognition software that is configured to recognize parties whose images are captured by the camera. It should be appreciated, however, that a camera may generally substantially attached to a client.

Server 508 also includes a data store 580, a processing arrangement 556, and application logic 560. Application logic 560 includes session establishment logic 564, recommendation logic 568, effective user creation logic 572, and party identification logic 576. Session establishment logic 564 is generally configured to establish a shared session, e.g., of an application associated with application logic 560, on server 508. Recommendation logic 444 may create recommendations, store recommendations in data store 580, and obtain recommendations from data store 580. Effective user creation logic 572 and party identification logic 576 may generally cooperate to identify parties logged into or otherwise authenticated by server 508, and to create an effective user that includes those parties.

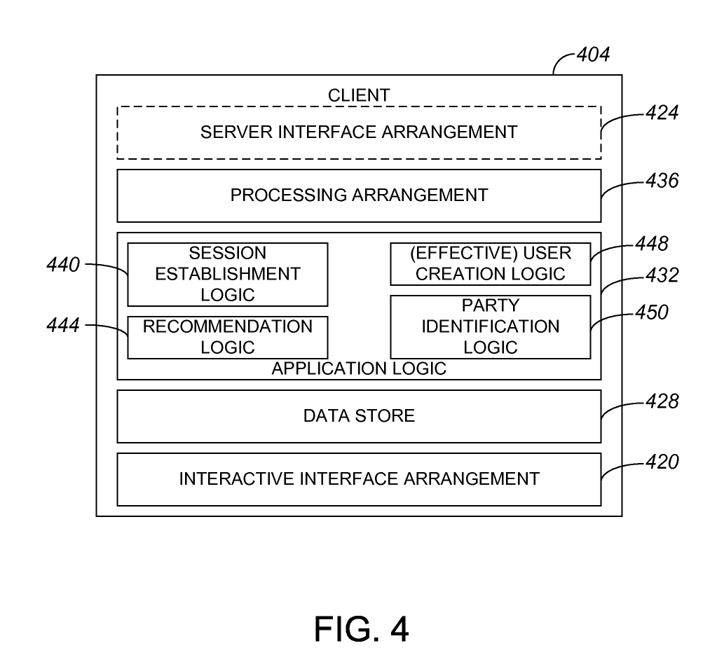

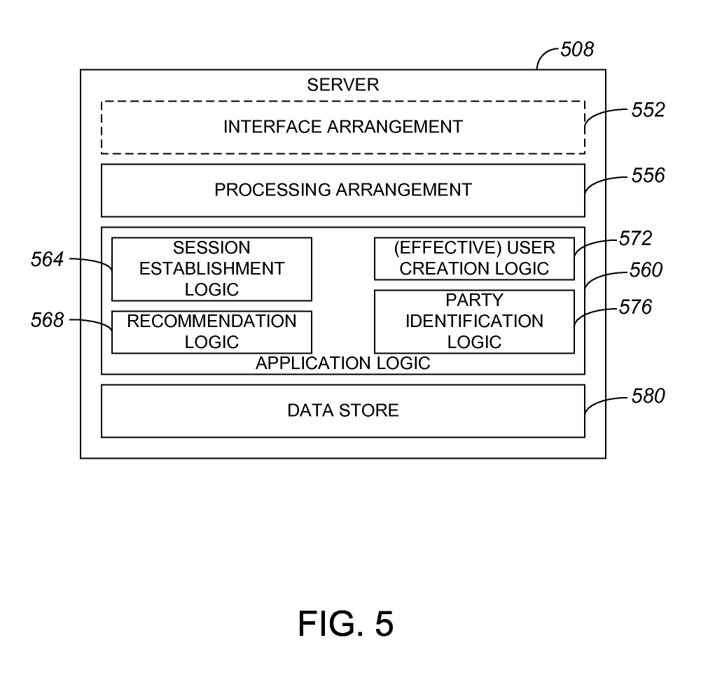

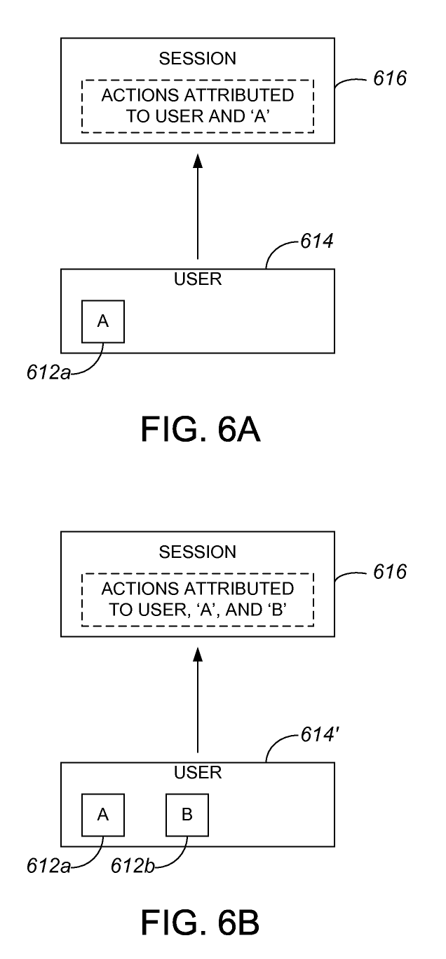

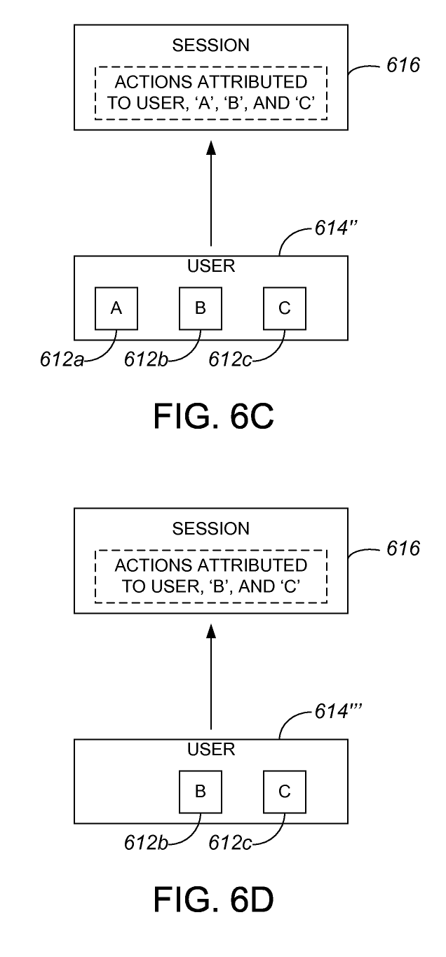

With reference to FIGS. 6A-D, interactions during a session while parties logged into the session change will be described in accordance with an embodiment. As shown in FIG. 6A, at a time t1, an effective user 614 includes a party A 612a that is logged into a session 616. Party A 612a may be logged into session 616 through a computing device (not shown), in one embodiment. Session 616 may be any suitable session, as for example a web or an http session. It should be appreciated, however, that session 616 is not limited to being a web or http session. Actions undertaken by effective user 614 may be attributed both to effective user 614 and to party A 612a.

While session 616 is active or otherwise ongoing, the number and identity of parties logged into session 616 on a computing device (not shown) may vary. For example, at a time t2 as shown in FIG. 6B, both party A 612a and a party B 612b are logged into session 616, and are associated with effective user 614′. Hence, actions by effective user 614′ with respect to session 616 may be attributed to or otherwise bound to effective user 614′, party A 612a, and party B 612b.

FIG. 6C is a diagrammatic representation of session at a time t3. At time t3, s party C 612c is also logged into session 616. As such, session 616 is shared by party A 612a, party B 612b, and party C 612c. Further, party A 612a, party B 612b, and party C 612c are associated with effective user 614″. Actions taken by effective user 614″ at time t3 may be attributed to effective user 614″, party A 612a, party B 612b, and party C 612c.

In addition to parties logging into session 616, parties may also log out of session 616. By way of example, at a time t4, party A 612a is no longer logged into session 616, as indicated in FIG. 6D. Party B 612b and party C 612c are associated with effective user 614′″, and remain logged into session 616. Therefore, actions taken with respect to session 616 may be attributed to effective user 614′″, party B 612b, and party C 612c.)

Although only a few embodiments have been described, it should be understood that the aspects of the disclosure may be embodied in many other specific forms without departing from the spirit or the scope of the present disclosure. By way of example, a session has generally been described as a web session or an http session. A session is not limited to being a web session or an http session. In general, a session may also be a gaming session, e.g., an online gaming session, a conference call, a phone call, an email session, a text messaging session, and/or an instant messaging session.

The implementation of the embodiments may vary widely. A party may join a shared session by providing credentials, e.g., a username and a password, through a user interface. In addition, to leave a shared session, when one party associated with an effective user accesses a user interface that allows the party to opt out of the shared session, the party may be presented with an option to disassociate any number of the parties associated with the effective user.

A party may effectively log into or otherwise be authenticated by a device that supports effective users using any suitable method. For example, as previously mentioned, a party may provide a username and/or a password using the device as an interface. A party may also be substantially sensed by the device, and effectively be automatically authenticated by the client. In one embodiment, if the device is a gaming console, a party may obtain a game controller that may be substantially sensed by the device. Sensing the game controller causes the party to effectively be sensed and, therefore, to essentially be associated with the device. In another embodiment, if the device is a computing system, a party may be substantially sensed by the device if the device includes a camera arrangement that identifies when an image of the party is captured. By way of example, face recognition capabilities may be provided on a game console.

Devices, e.g., client devices, which are suitable for supporting effective users may vary widely. Devices may include, but are not limited to including, phones, computers, game players or consoles, media players, and the like. Applications which may support access by multiple effective users may include, but are not limited to including, gaming applications, media applications such as movie applications and video clip applications, and the like.

In general, actions such as events which occur during a shared session may be attributed to substantially all parties associated with an effective user. Other actions, as for example web interactions, may also be attributed to substantially all parties associated with the effective user. As will be appreciated by those skilled in the art, web interactions may generally be actions which handle transactions, user identification, and user logins through http sessions. For a web interaction that involves shopping, a purchase of a product by the effective user may result in the product being shipped to each party associated with the effective user. In addition, for a web interaction that involves sending an email, a message that is sent by the effective user may essentially be sent from each party associated with the effective user to a recipient or a list of recipients.

The embodiments may be implemented as hardware and/or software logic embodied in a tangible medium that, when executed, is operable to perform the various methods and processes described above. That is, the logic may be embodied as physical arrangements or components. Such physical arrangements or components may generally be embodied on any suitable tangible medium, e.g., in memory.

The steps associated with the methods described above may vary widely. Steps may be added, removed, altered, combined, and reordered without departing from the spirit of the scope of the present disclosure. By way of example, while recommendations presented to an effective user have been described as changing when the number of parties associated with the effective user change, it should be appreciated that recommendations may also change when the number of parties remains substantially the same but the identity of the parties changes. In other words, while the identity of the parties associated with an effective user may change and, thus, recommendations provided to the effective user may change, even while the number of parties associated with the effective user remains substantially the same.

What is claimed is:

1. A method comprising:
establishing a session by associating at least a first party with the session, the at least first party being associated with a first device, wherein the at least first party is associated with the session through the first device;
defining an effective user, the effective user being defined to include the at least first party;
tracking actions taken with respect to the session by the effective user; and
attributing the actions taken with respect to the session by the effective user to the at least first party and to the effective user.

2. The method of claim 1 further including:
determining when at least a second party has joined the session, the at least second party being associated with the first device, wherein the second party joins the session through the first device;
redefining the effective user to include the second party when it is determined that the at least second party has joined the session, wherein tracking the actions taken with respect to the session by the effective user includes identifying a first set of the actions taken with respect to the session by the effective user after the effective user is redefined; and
attributing the first set of the actions taken with respect to the session to the at least first party, the at least second party, and the effective user when it is determined that the at least second party has joined the session.

3. The method of claim 2 wherein determining when the at least second party joins the session includes determining when the at least second party has been authenticated by the first device.

4. The method of claim 2 wherein when the at least second party has joined the session, the method further includes:
determining when the at least second party has unjoined from the session; and
redefining the effective user to not include the second party when it is determined that the at least second party has unjoined from the session, wherein attributing the first set of the actions taken with respect to the session to the at least second party occurs after the at least second party has unjoined from the session.

5. The method of claim 4 wherein when the at least second party has unjoined from the session, tracking the actions taken with respect to the session by the effective user includes identifying a second set of the actions taken with respect to the session by the effective user after the effective user is redefined to not include the at least second party, the method further including:
attributing the second set of actions taken with respect to the session to the at least first party and the effective user.

6. The method of claim 1 further including:
determining if at least one recommendation associated with the effective user is locatable, the at least one recommendation being associated with previous actions attributed to the effective user;
obtaining the at least one recommendation associated with the effective user if it is determined that the effective user is locatable; and
presenting the at least one recommendation using the first device during the session if it is determined that the at least one recommendation associated with the effective user is locatable.

7. The method of claim 1 wherein the session is one selected from the group including a web session and a hypertext transfer protocol (http) session.

8. Logic embodied on a tangible media that, when executed, is operable to:
establish a session by associating at least a first party with the session, the at least first party being associated with a first device, wherein the at least first party is associated with the session through the first device;
define an effective user, the effective user being defined to include the at least first party;
track actions taken with respect to the session by the effective user; and
attribute the actions taken with respect to the session by the effective user to the at least first party and to the effective user.

9. The logic of claim 8 further operable to:
determine when at least a second party has joined the session, the at least second party being associated with the first device, wherein the second party joins the session through the first device;
redefine the effective user to include the second party when it is determined that the at least second party has joined the session, wherein the logic operable to track the actions taken with respect to the session by the effective user is further operable to identify a first set of the actions taken with respect to the session by the effective user after the effective user is redefined; and
attribute the first set of the actions taken with respect to the session to the at least first party, the at least second party, and the effective user when it is determined that the at least second party has joined the session.

10. The logic of claim 9 wherein the logic operable to determine when the at least second party joins the session is further operable to determine when the at least second party has been authenticated by the first device.

11. The logic of claim 9 wherein when the at least second party has joined the session, the logic is further operable to:
determine when the at least second party has unjoined from the session; and
redefine the effective user to not include the second party when it is determined that the at least second party has unjoined from the session, wherein the logic operable to attribute the first set of the actions taken with respect to the session to the at least second party occurs after the at least second party has unjoined from the session.

12. The logic of claim 11 wherein when the at least second party has unjoined from the session, the logic operable to track the actions taken with respect to the session by the effective user is further operable to identify a second set of the actions taken with respect to the session by the effective user after the effective user is redefined to not include the at least second party, the logic still further operable to:
attribute the second set of actions taken with respect to the session to the at least first party and the effective user.

13. The logic of claim 8 further operable to:
determine if at least one recommendation associated with the effective user is locatable, the at least one recommendation being associated with previous actions attributed to the effective user;
obtain the at least one recommendation associated with the effective user if it is determined that the effective user is locatable; and
present the at least one recommendation using the first device during the session if it is determined that the at least one recommendation associated with the effective user is locatable.

14. The logic of claim 8 wherein the session is one selected from the group including a web session and a hypertext transfer protocol (http) session.

15. An apparatus comprising:
means for establishing a session by associating at least a first party with the session, the at least first party being associated with a first device, wherein the at least first party is associated with the session through the first device;
means for defining an effective user, the effective user being defined to include the at least first party;
means for tracking actions taken with respect to the session by the effective user; and
means for attributing the actions taken with respect to the session by the effective user to the at least first party and to the effective user.

16. The apparatus of claim 15 further including:
means for determining when at least a second party has joined the session, the at least second party being associated with the first device, wherein the second party joins the session through the first device;
means for redefining the effective user to include the second party when it is determined that the at least second party has joined the session, wherein the means for tracking the actions taken with respect to the session by the effective user include means for identifying a first set of the actions taken with respect to the session by the effective user after the effective user is redefined; and
means for attributing the first set of the actions taken with respect to the session to the at least first party, the at least second party, and the effective user when it is determined that the at least second party has joined the session.

17. An apparatus comprising:
an application logic, the application logic being arranged to establish a shared session and to track actions taken with respect to the shared session, the application further being arranged to define an effective user; and
an interface, the interface being configured to allow a first party to participate in the shared session, the interface further being configured to allow a second party to join the shared session, wherein the application logic is further arranged to associate the first party and the second party with the effective user, the application logic still further being arranged to attribute the tracked actions to the effective user, the first party, and the second party.

18. The apparatus of claim 17 wherein the interface is arranged to authenticate at least the first party and the second party.

19. The apparatus of claim 17 further including:
a server interface arrangement, the server interface arrangement being configured to allow the apparatus to communicate with a server, wherein the application logic is configured to establish the shared session such that the shared session is associated with the apparatus and the server.

20. The apparatus of claim 17 wherein the application logic includes recommendation logic, the recommendation logic being arranged to process the tracked actions to provide recommendations to the effective user during the shared session.

21. The apparatus of claim 20 wherein the recommendation logic is further arranged to determine if any previous recommendations associated with the effective user are locatable, and if the previous recommendations associated with the effective user are locatable, the recommendation logic is still further arranged to provide the previous recommendations to the effective user during the shared session.

22. The apparatus of claim 17 wherein the application logic is further arranged to determine when at least the second party has unjoined the shared session, wherein the application logic is arranged to redefine the effective user to not include the second party and to attribute the tracked actions to the second party when the second party has unjoined the shared session.
